(19) United States
(12) Patent Application Publication
(10) Pub. No.: US 2018/0181555 A1
(43) Pub. Date: Jun. 28, 2018

(54) REWRITING FORMS FOR CONSTRAINED INTERACTION

(71) Applicant: Ohio State Innovation Foundation, Columbus, OH (US)

(72) Inventors: Arnab Nandi, Columbus, OH (US); Protiva Rahman, Columbus, OH (US)

(21) Appl. No.: 15/855,515

(22) Filed: Dec. 27, 2017

Related U.S. Application Data
(60) Provisional application No. 62/439,277, filed on Dec. 27, 2016.

(51) Int. Cl. G06F 17/24; G06F 8/38; G06F 3/0484; G06F 3/0482

(52) U.S. Cl. CPC G06F 17/243; G06F 3/0482; G06F 3/0484; G06F 8/38

(57) ABSTRACT

The innovation describes and discloses methods and systems that improve system performance for technical communication systems by providing transformed forms from input form attributes and a plurality of target technical display environments. Since certain technical display environments may have constraints that provide limitations in the visualization and interactions of original forms designed for a purpose that does not take into account the possible variety of technical display environments, the disclosed innovation provides a transformed structure that is rendered in a target constrained technical communication environment. For each input field of the input form, the innovation creates new structure based on input cost factors determined from an original form, prior input form data and available display dimensions of a constrained communication environment. The transformed form improves system processing characteristics including reductions in time and potential error rates.

### CROSS-REFERENCE TO RELATED APPLICATIONS

This application claims the benefit of U.S. Provisional Patent Application 62/439,277 entitled “REWRITING FORMS FOR CONSTRAINED INTERACTION” filed on Dec. 27, 2016. The entirety of the above-noted application is incorporated by reference herein.

### BACKGROUND

The innovation disclosed herein relates to systems and methods of augmenting aspects of electronic communications providing for transformed technical layouts of forms to compensate for device constraints which yield system improvements in throughput and accuracy.

A problem arising specifically in the arena of electronic communications is how to technically share data that may be relatively easy to see and handle in one technical environment, but does not migrate well into a different technical environment. Technical constraints driving this issue include the fact that technical systems may have a variety of display technology, such as for example a device small screen size, or in another example a lack of or diminished physical keyboards, for example in smartphones, tablets, and smartwatches. Typical results of these types of system inefficiencies may include a high degree of imprecision during user interaction. Often, for example, technical constraints may make it difficult to fill out online forms, especially as the online forms may be accessed through a variety of different devices. Partial rendering of a single page of a form may often require a user to zoom, pan, and scroll in order to interact with all parts of the form. Data interactions (and the possibility of errors therein) related to form-filling may depend on the design of a form and the expected values that are to be entered driven by one technological context without regard to other technological contexts in which the original form may appear. With the rising popularity of a multitude of various electronic devices with inherent variations in technical interaction capabilities, for example screen size, the state of the art methods of manually designing optimized forms for each device (or device-database combination) is time consuming, expensive, and plainly insufficient. Merely automating such manual items is likewise insufficient. It is to be appreciated that since manual modes are found not to work well, that efforts at merely automating that which was manual would result in merely making “not working well” be arrived at faster. Thus substantially more than merely automating manual efforts are required for the technical solutions as revealed in the present disclosed innovation.

To provide context, and not limitation, many daily activities such as ordering food and booking appointments may require forms to be filled out. Naturally, prior to the explosion of electronic communications, paper forms were the norm. As electronic processing became more mainstream, more activities were called to be completed via an electronic device, e.g., online. This shift to a technological environment (from paper to digital) has introduced technical issues that were absent in the manual world. Such issues may include the rise of constrained display touch devices such as smartphones, tablets, or the like. In some contexts, smartphones and tablets are expected to become the sole mode of interaction. Further, with the advent of wearables such as smartwatches and smart glasses, oftentimes it may arise that a singular mode of interaction for a user may be through gestures. Thus, an increased number of people are using constrained display, touch-based, or other technically-limiting devices to fill out forms.

However, most web pages and online forms are not optimal for small viewport devices since they are either directly copied (manual conversion) from their paper versions or are designed (from scratch) for a different technical environment, such as for desktop interfaces. In the case of the former, the paper form design may be translated onto a web page using only text input, which induces an especially difficult issue in filling out fields on small screen devices. In the example of the latter case, the form presumes a large screen size and may often use a multiple column layout. Forms in such a technical environment may require a user to scroll both horizontally and vertically or a communication system may provide tools to enable a panned view to fit a screen. Panned views may be adequate, or at least not as intrusive, for a browsing website in certain technical environments, but for forms and the like, certainly the limitations of newer devices and platforms present impair that adequacy. In such different technical environments, a user may be required to zoom in order to accurately provide input (for example, for an environment in which a User Interface widget size is too small). Further, upon zooming, they might have to scroll back and forth if the field label is not directly visible. In other words, a structure of a graphical user interface may induce technical system difficulties and limitations that impact the technical system operations. As noted in the America Invents Act, technical improvements at least as related to graphical user interfaces are the type of innovation for which patent protection is intended to be sought.

Further, in the world of electronic data processing, existing systems and methods provide for limited abilities when it comes to interacting with a given form across multiple devices or platforms. As the world evolves to a plethora of interconnectedness, this lack has been dealt with mainly in ad hoc or non-systemic manners, and efforts to create improvements in the underlying technical environment have been largely lacking.

Some prior art efforts have focused on automating form creation. For example, the system designed in K. Chen et al.'s “Shreddr: pipelined paper digitization for low-resource organizations” (in ACM Symposium on Computing for Development, 2012) automates the conversion of paper forms to an online database by processing annotated images of the paper forms. However the effort does not optimize forms for the web (or any number of other technical viewing platforms) and thus remain limited. Likewise, the efforts of L. Tang, T. Li, Y. Jiang, and Z. Chen in “Dynamic query forms for database queries” (TKDE, 2014) describe a system that takes as user input form fields, and semantic axes under which to group fields as well as validation checks defined by business rules and from this creates a graph where each vertex is a form field and each weighted edge represents how interrelated the two fields are. The effort then uses a graph partitioning algorithm to create webpages. While this technical advance was a step forward, the authors redesign web forms had used guidelines outlined in J. Bargas-Avila et al.'s “Simple but crucial user interfaces in the world wide web: introducing 20 guidelines for usable web form, design” (INTECH Open Access Publisher, 2010), but they attempt these web forms manually, thus their efforts remain limited as well.

Other conventional attempts may focus on redesigning general webpages by splitting pages based on HTML Document Object Model (DOM). However, these are targeted towards optimizing browsable content and do not consider the different technical issues that may arise from user interaction involved in filling forms. Manual redesigning of webpages for different devices is also common, however this approach is also limited as being of a “one-off” nature and becomes difficult to maintain, especially with the increase in variations of device types and sizes. Tools such as Bootstrap may adapt widget size and page layout to a screen size, but such do not modify widget type or take a database (for example, a database related to the data within any type of form) into consideration. Hence, not only is a need for functionality that redesigns web forms for constrained display touch devices unmet, the set of challenges in such a technical path have not been identified in the prior art efforts.

Other technical efforts geared to the creation of form designs, such as J. Heer and B. Shneiderman in “Interactive dynamics for visual analysis” (Queue, 2012) and W. Willett et al. in “Scented widgets: Improving navigation cues with embedded visualizations.” (IEEE TVCG, 2007). These technical efforts have aimed at embedding widgets with visualization to provide navigation cues. While these works may also customize widgets based on data, the efforts serve to merely guide user navigation as opposed to focusing on ameliorating the technical issues associated with form filling.

Webpage design efforts, such as for example D. Ritchie et al. in “D. tour: Style-based exploration of design example galleries: (UIST. ACM, 2011) may provide search interfaces for webpage designs. This type of work relates to general web page design and is targeted towards web developers starting from scratch. However, redesign and starting from scratch provide technical solutions for different aspects than as covered herein, and thus are geared to separate innovations.

Other technical efforts have evaluated singularly different aspects of some of the technical issues arising in the electronic communications arena, but attempting to make a raw combination may not be amenable, due to an exponential time penalty. For example, constraint solving algorithms such as by Cassowary have been widely adapted to layout pages. But attempting the same mechanism for both widgets and layout together incurs a technical penalty of exponential time processing rendering such a path inappropriate for attempting to find solutions for the types of technical resolutions addressed by the disclosed innovation. Such a penalty is avoided with aspects of the disclosed innovation.

Widget selection also impacts other technical avenues. For example, A model known as the GOMS model—as discussed by E. John and D. E. Kieras in “Using goms for user interface design and evaluation: Which technique?” (TOCHI, 1996), aims to evaluate system usability by using selection rules based on goals and methods to predict user behavior. Such an effort does not account for the data characteristics and hence cannot be used for widget selection.

Further, technical advances in user interfaces that focus on data driven approaches may improve database schema actions, for example reducing reliance on specific querying languages, and while technical systems have been developed in support of these efforts, limitations persist as to technical aspects such as keyword matching and transformations, query parsing, and automating processes (showing yet again that “mere automation” does not suffice). Many of these technical efforts are focused singularly on form or data specifics, or are geared to a single preset technical viewing environment and thus remain limited.

Similarly, technical efforts for adapting web pages for multiple devices through a variety of technical efforts are mainly applicable for browsing webpages and fail to address the unique challenges of data interactions (for example, filling out a form) and leveraging the data to customize widgets across multiple viewing techniques. It is one thing to browse, but a different set of technical considerations need be accounted for in form filing and data leveraging interactions. These are at least some of the aspects to which the present disclosed innovation addresses.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

Communication system impacts are highly susceptible to time impacts, both in processing operations and live interactions. The technical requirements are often driven by a need for speed. Communications in this forum then may be thought of as a data pipeline, or perhaps more accurately technical improvements to communication systems may arise in how managing a data pipeline may be undertaken. The creation of data through forms is often one of the most time consuming steps in a data pipeline. Small screen size and lack of a physical keyboard in today's mobile devices, such as smartphones, tablets, and smartwatches, introduces imprecision during user interaction. The difficulty associated with filling out forms in a constrained technical environment impacts system performance and efficacy.

It is to be appreciated and understood that, while examples presented herein may disclose a data entry form, the innovation is equally applicable to query forms and other forms associated with user interactions.

The innovation describes and discloses systems (and methodologies) that transforms forms for constrained input settings. In an embodiment, aspects of a form, for example, data, data fields, or form schema may be captured and processed in a database. Processing may then locate or develop a plurality of user interface widgets to transform the form based at least in part on a derived expected “input cost” factor. Processing may take into account contents of the database, for example, for each input field, aspects considered may include schema information and data distribution, as well as a target available display dimensions.

The system thus may determine an ideal widget size and may split a form into multiple pages (for example, doing so to reduce scrolling, panning, etc). Through user studies over real-world forms, it has been demonstrated that aspects of the innovation provide a significantly improved user experience with, for example, up to a 50% reduction in form completion time between the original and transformed forms, thus improving the technical environment.

It is to be appreciated that often a decision on a particular selection of a widget for a single particular form field may be subjective. For example, in certain situations, it may be a close call as to which is easier: “to select from choices” rather than “to type” on a constrained display device. However, if the number of choices is large, typing may become more convenient than scrolling through all the options. However, there may be no definite measure of at what point the number of options is “too many”. Further, even if the number of values is small, a widget choice may be still ambiguous, or several options may be equally advantageous. For example, radio button, range slider and dropdown all appear to be reasonable choices for a height field. An aspect of the disclosed innovation takes such close calls into account in the manner by which the entirety of a form is analyzed, data captured in a database is processed, and input cost factors are determined.

The disclosed innovation may redesign a form for most any given display dimension using a cost model that leverages the schema and data distribution captured in a form database to select and layout widgets. In an embodiment, the disclosed innovation's tunable cost model captures the difficulty of filling the form by estimating the time for each type of user interaction. In an embodiment, evaluation showed that the redesigned forms produced by the innovation significantly reduced the form completion time, even if the users had to correct errors. Moreover users generally ranked the redesigned forms as being easier to use than the original form.

Thus, the innovation effectively restructures forms for constrained devices, allowing more efficient system processing. With growing variety in shapes, sizes and interfaces of devices, the disclosed innovation provides a seamless experience to a user on most all devices, without effort on part of an original form developer who may need only design and maintain one version of a particular form outside of transformed forms presented with the aid of the disclosed innovation.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example embodiment of a method in accordance with an aspect of the innovation.

FIG. 2 illustrates an example embodiment of additional details of a method in accordance with an aspect of the innovation.

FIG. 3 illustrates an example embodiment of additional details of a method in accordance with an aspect of the innovation.

FIG. 4 illustrates example widgets in accordance with an aspect of the innovation.

FIGS. 5A and 5B provide a sample improvement possible with an implementation of the innovation.

FIGS. 6A and 6B provide a sample improvement possible with an implementation of the innovation.

FIGS. 7-10 provide sample results of example embodiment of an implementation of the innovation.

FIG. 11 provides an example computing system in accordance with an application of aspects of the innovation.

FIG. 12 provides an example system in accordance with an aspect of the innovation.

### DETAILED DESCRIPTION

In the following description, for purposes of explanation, numerous specific details are set forth in order to provide a thorough understanding of the subject innovation. It may be evident, however, that the innovation can be practiced without these specific details. In other instances, well-known structures and devices are shown and/or described in order to facilitate describing the innovation.

While specific characteristics are described herein, it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and/or described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. As is known in the art, software may have an equivalent in hardware, such as in an Application Specific Integrated Circuit (“ASICs”) module or a Field Programmable Gate Arrays (“FPGAs”) module. By way of illustration, both an application running on a server and the server can be a component. One or more components can reside within a process and/or thread of execution, and a component can be localized on one computer and/or distributed between two or more computers.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

Redesigning a form for a constrained screen may involve selecting widgets for each field and breaking the form into multiple pages, for example, in order to eliminate scrolling. In an embodiment of the innovation, a formulation of a redesign of a form may be processed as a minimization of a cost function. These types of transformation may be considered to be of a class of “hardness” of a problem, as will be discussed herein. Relevant terms are clarified in context through definitions provided in Table 1.

TABLE 1

| | |
|---|---|
| Form | An ordered list of form fields which may include |
| | fields requiring user input, rendered as HTML |
| Form Field | Each element on a form, some of which may require input |
| Widget | User Interface element for entering data, dependent |
| | on input type of a field (for example, radio |
| | button, checkbox, etc.). |
| Data | Data values entered for a corresponding database column |
| Data Type | Data type for each column as defined in a schema |
| | that is a factor in deciding widget choices. Examples |
| | include numeric, non-numeric, mixed, specialty (i.e., |
| | social security number), and the like |
| Database | Electronic structure serving as transformation |
| | tool, wherein a form serves as query interface and |
| | each form field corresponds to a column. Submitting |
| | a form is thus equivalent to issuing an insert or select |
| | query having a where clause with the columns equal |
| | to the values entered by users in analogous form fields. |
| Data | Frequency of each data value that can |
| Distribution | be used to order the options in widgets that list them |

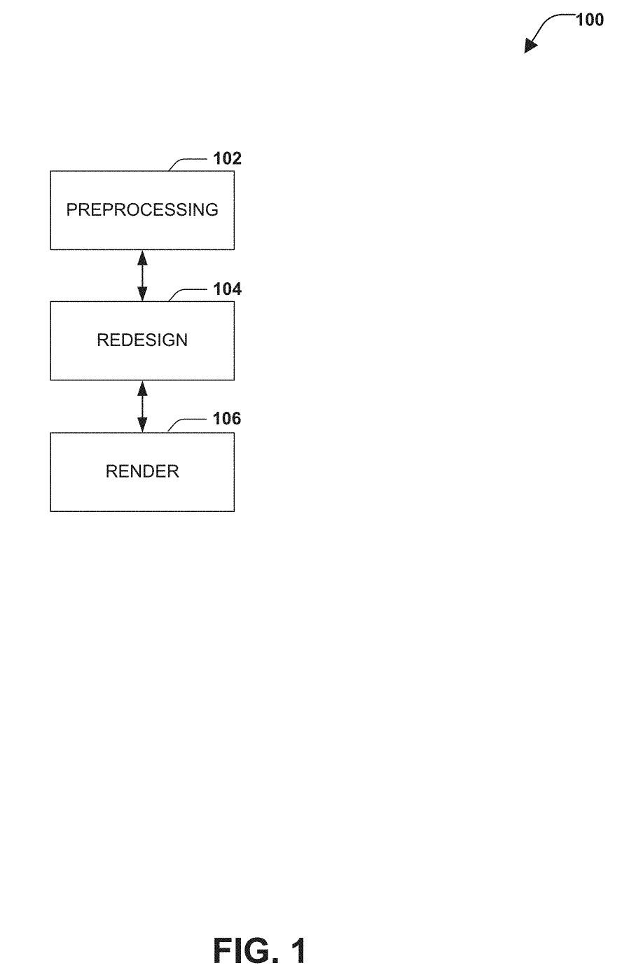

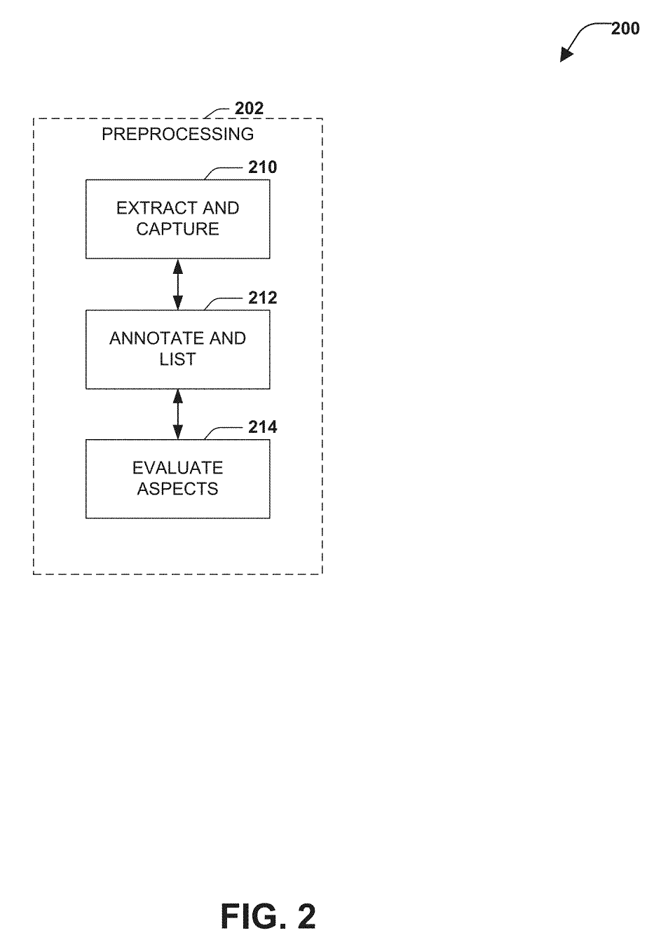

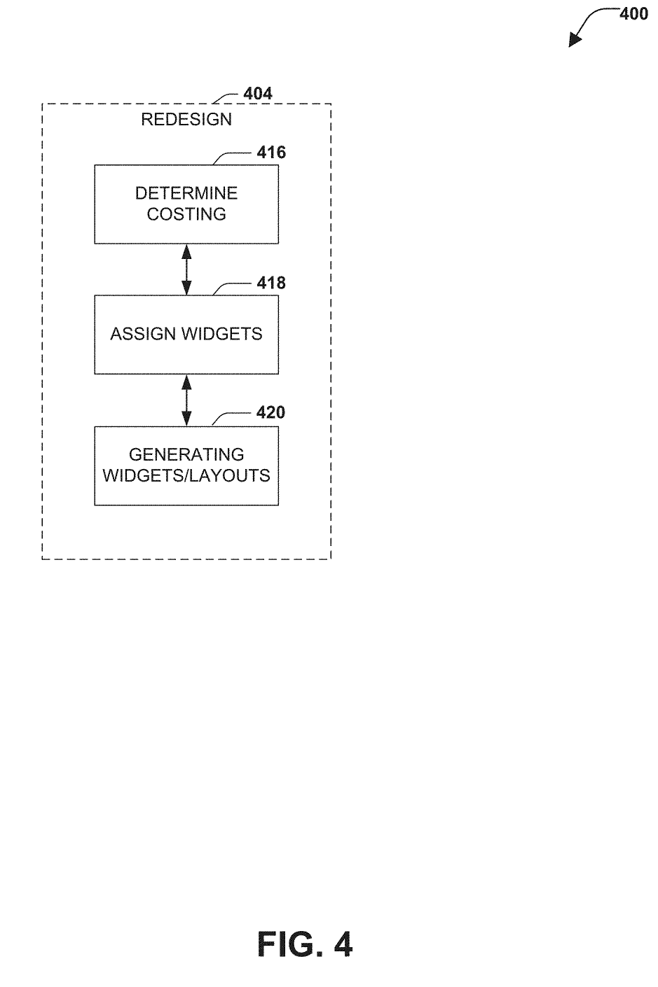

Turning now to FIG. 1, an example method 100 of an embodiment of the innovation is disclosed. At preprocessing step 102 the method accepts as input an original form. Preprocessing includes transformation/translation of the form to a type-annotated intermediate representation. The transformation includes identifying and cataloguing the various attributes of the form and form fields. Creating an intermediate representation includes processing a distinct cardinality and length of string for categorical/string attributes, and ranges for numerical attributes that may occur, which is then used to compute an optimized form based on a number of factors in redesign 104. It is to be appreciated that the preprocessing at 102 provides the ability to take as intake a wide variety of forms that may originally have been designed for a multitude of communications, including, for example, paper forms manually automated for an electronic environment, as well as forms expressly created for one particular electronic environment (that may be used in a different electronic environment). At step redesign 104 factors may include creating a cost of interaction in a constrained setting that enriches the intermediate representation with an ideal widget, page number and display height. Details of process steps are discussed in more detail in relation to embodiments discussed in FIGS. 2-4. The intermediate representation along with the data distribution of each field may be used to generate redesigned HTML pages which are rendered at 106. Rendering is discussed in more detail later at the conclusion of the discussion for FIG. 4.

Turning to FIG. 2, method 200 presents a more detailed view of a preprocessing step, for example preprocessing step 202 may be preprocessing step 102 of method 100. At preprocessing step 202 an embodiment uses an original form and gathers and captures 210 information on the form fields to a database. The innovation may use an extraction technique, for example, a technique such as Beautiful-Soup to extract input elements of the form. The embodiment also extracts and stores 210 labels associated with each tag. Further, the embodiment keeps track 210 of the checkbox and text input types, since these may affect widget selection.

An embodiment may then query the database to collect 210 additional information about the fields. For each field, the embodiment parses the schema to check if its data type is numeric or date. For these two data types, the embodiment may use a minimum and maximum allowable value for cost factor calculations (as will be discussed later). For each field, an embodiment may also execute a count query 210 to calculate the number of distinct values and the length of the largest value stored in a predetermined number of first records. It is to be appreciated that this feature may be “interactive” or may update based on changes in a database. This information may be stored in a database catalog. Output of preprocessing includes a list of the form fields annotated with data type, data range and label for the respective fields 212. The entire step takes linear time in the number of fields in the form.

In certain embodiments, preprocessing step 202 may proceed to evaluate aspects 214. The disclosed innovation in some embodiments includes this step based on insights that have been gathered from user studies. These insights include: the most time consuming element of the original forms is a small widget size which required users to zoom in. Thus, it may be beneficial to specify a minimum widget size that the user can easily interact with as well as balancing a widget size that provides minimal scrolling. Target trade-off values may be output from preprocessing 202. Further, embodiments may have optimizations such as making labels interactive for radio buttons and checkboxes, and/or increasing the size of the handle of the range slider in order to help reduce processing time.

Another insight is that after users zoom in to original forms, scrolling in both directions for two columnar forms becomes necessary. Thus, the disclosed innovation drives to reduce scrolling. In some embodiments this may be achieved by placing the label for text widgets as the placeholder in the widget. In some embodiments this may be achieved by displaying labels on top of the rendered widget.

It is to be appreciated that identifying, and extracting underlying form semantics such as hidden input fields which are dependent on other input fields is non-trivial. This insight yields that in some embodiments a cost model may be extended to capture aesthetics, such as locating optimal distance between fields in a page or choosing color schemes. In some embodiments, showing images instead of text options may provide for less space, such as displaying colors for hair and eye color fields.

Yet another insight is that text inputs may be the most probable cause of errors and thus may take up the most time (entry, and then correction). Another embodiment of the innovation may transform such with widgets employing voice recognition or autofilling suggestions. In some embodiments, forms that may be unique or that may access the same database in subsequent use (either by the same or different user) may thus leverage previous captured inputs, and embodiments may include guides for a subsequent use based on the leverage.

Another evaluated aspect that may be a part of evaluate aspect 214 is the insight that meaningfully grouping fields together can impact form completion time. In one embodiment of the innovation, an algorithm may place fields where they fit on a “greedy” basis, but in another embodiment, semantic grouping of fields can aid the user in quickly filling forms. Semantic grouping may be done by analyzing schema relations and, for example, keeping elements that appear in the same table together, or as another example, using an ordering of fields in an original form as a weighted factor in cost calculations (cost calculations are discussed later in relation to FIG. 4).

Machine redesigned forms created according to the disclosed innovation that uses data customized widgets provides significant reduction in processing time and embodiments of the innovation were preferred by device users over original forms.

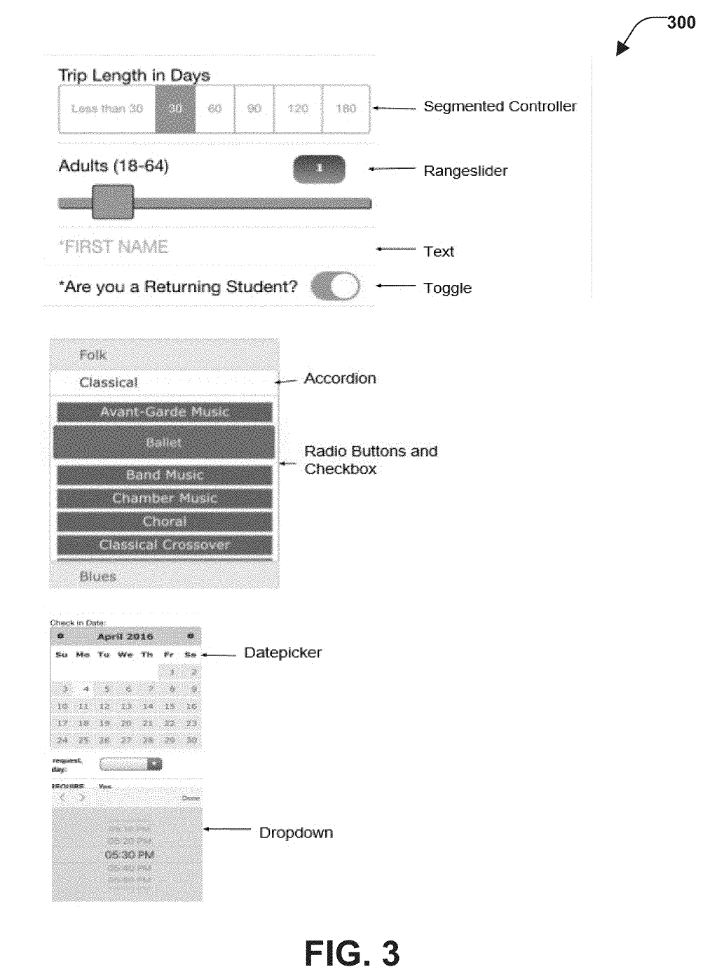

Turning briefly to FIG. 3, various example widgets are portrayed. Disclosed are nine selected widgets that may appear in redesigned forms and each selected widget may represent various input types. These example widgets include Radio buttons for selecting one from many options, Checkbox for selecting many options from a list, Range sliders for numeric and hierarchical fields, Datepicker, which is a small calendar showing all 31 days and buttons for navigating through months and years, Segmented controller which shows multiple options in a horizontal row, Dropdown widget shows options in a dropdown list upon clicking, Accordion widget which shows headings which expand to show options on click, for fields that have multiple options that need to be grouped together, Toggle widget is for fields that have binary choices, and Text input.

Turning to FIG. 4, method 400 presents a more detailed view of a redesign step, for example redesign step 404 may be redesign step 104 of method 100. In an embodiment, at redesign step 404, the following may occur: at step 416, costing is determined. In an embodiment, cost of an input field may be calculated given the field, widget and available display height along with information collected in the preprocessing step. Different widgets are costed differently. For example, cost of radio buttons may be determined as the weight of one tap wₜₐₚ+scrollcost. Scrollcost may be calculated as the height provided to display all options divided by the available display height, multiplied by scroll weight. To make it easy for a user to select an option, an option may have a minimum height of 30px, so height desired may be equal to a distinct cardinality or count multiplied by 30. Checkboxes may be similar, except a tapping cost is the count multiplied by wₜₐₚ since in worst case a user could select all options. The cost of range slider may be equal to a count multiplied by sliding weight w_{slide}, which for numeric fields may be calculated from the max and min values. The datepicker cost may be 12×wₜₐₚ, for selecting month+wₜₐₚ×range of years, which may be calculated from a max and min+2 to select date, if it is a date field, otherwise such may be inapplicable. Cost of a segmented controller may be wₜₐₚ if all the option fits on a screen width, which can be calculated by summing the length of the data points for that field from the database, otherwise the widget may be inapplicable. Cost of dropdown may be equivalent to scrolling through each of the options and typically takes two taps; hence cost may be equal to the number of options×w_{slide}.+2×wₜₐₚ. The cost of accordion may be the cost of scrolling through the headings+cost of scrolling through the subheadings+2×wₜₐₚ for the tapping costs. The cost of the toggle input may be 2 if the column is binary, i.e., has only yes or no options (or may be “n” if “n” columns are ascertained), otherwise the cost may be inapplicable. Finally the cost of text input may be the length of the longest string multiplied by typing weight of 7 w_{type}.

An aspect of the disclosed innovation may be based on a cost-based approach. When redesigning a form, the disclosed innovation may leverage data for a field and display dimensions of the device to select the best widget. For example, if the column contains only two distinct values then, a radio button may be an appropriate widget whereas if the column contains a continuous range of numeric values, a slider widget might be more ideal. However, in many cases the domain of the data is so large that the only option may be to use a text input field such as in the case of proper nouns. To represent this association between the data and the widget, the innovation may define an input cost that measures the suitability of using a particular widget for a field and hence measures the difficulty. Difficulty may be proportional to form completion time, and in this embodiment, refers to the ease of use of the widget and not on form semantics such as error messages i.e., it is easier and quicker to select an option using radio buttons than it is to type it into a text field. Hence, the innovation may define a cost function that estimates the form completion time.

Types of interactions: Each user interaction may be broadly classified into four distinct categories that contribute differently to the completion time and hence the cost: tap, scroll, slide and typing on soft keyboard.

In an embodiment of cost functions, for a particular field, an input cost may be a sum of a tapping cost, a sliding cost, a typing cost and a scrolling cost. The tapping cost is equal to a total number of taps provided to make a selection for that field multiplied by a tapping weight. The sliding cost is a range of values being represented on a slider multiplied by a sliding weight since as the range becomes larger exactly selecting a particular value on the slider may be it become more difficult. The scrolling cost is a total number of options to scroll through divided by a number of options visible at a given moment. The typing cost for a field is measured as a length of a longest data element multiplied by a typing weight. The cost for field i may thus be:

costᵢ=tapᵢ×wₜₐₚᵢ+slideᵢ×w_{slid}+typeᵢ×w_{typ}+scrollᵢ×w_{scrol} (1)

where tap, is the total number of taps, slideᵢ is the range of the slider, type, is the maximum allowable length that can be typed into a text field and scroll, is the total number of options divided by the number of options visible for field i, Wtap, Wslide, Wtyp, Wscrol represent the respective weights. Description of tuning of weights involved with the innovation are contained herein.

An aspect of the disclosed innovation deals with the concept of “Hardness”: In conjunction with selecting an ideal widget, an embodiment of the innovation also may split a form into multiple pages to avoid scrolling, in case the form with the innovation's resized widgets does not fit in a constrained screen. When splitting the form, the embodiment may maintain interactive widget sizes in order to achieve space efficiency and to keep the total number of pages at a minimum. Having multiple pages adds a cost of a tap to navigate to the next page. The overall cost may be reduced by selecting a different combination of widgets that take less space overall. Moreover, a cost of a widget field combination may change depending on where the combination is placed on a page. For example, if a field used radio buttons, but lacked enough space to display the field, a cost would then include scrolling cost for that widget. Hence, to obtain the optimal grouping, an embodiment may consider costs of all combinations of input fields with all widgets, which takes an NP Hard problem and applies solutions to a new effect as integrated into the disclosed innovation.

NP Hard problems may include an instance of a weighted set cover problem in determining a minimum cost form layout. Provided that a form has n input fields and the disclosed innovation has k different widgets that the may be used. Then let the universal result set may be the set consisting of all fields:

U={f₁,f₂, . . . ,fₙ} (2)

Let W be the set of widgets:

W={w₁,w₂,w₃, . . . ,wₖ} (3)

Then f₁^{w}ⱼ corresponds to using widget wⱼ for field fᵢ and V is the set containing all combinations of fields being represented by different widgets:

V={f₁^{w}^{₁},f₁^{w}^{₂}, . . . ,f₁^{w}^{ₖ},f₂^{w}^{₁}, . . . ,fₙ^{w}^{ₖ}} (4)

Y={S⊂V:fᵢ^{w}^{ₓ},fⱼ^{w}^{_{y}}∈S⇒i≠j,1≤i,j≤n} (5)

That is S is the set of all the ordered subsets of V which contains each field at most once. Each member of Y represents laying out the fields on a page in the order they appear in the set, using the given widget. The weight cs for each S∈Y is the sum of the costs for each field, according to the widget being used as defined in (1). Then a minimum weight subset cover of U will be a solution to the innovation's form redesign where each subset represents a page and elements of the subset dictate the ordering of the fields along with the widget choice.

At 418, assignment of widgets is conducted. This may be conducted with an algorithm and the algorithm may use output from a preprocessing step, for example, a list of form fields annotated with data type and range to calculate cost, and assigns a widget to each field along with a page number and the order it appears on for that page. Example pseudo-code for an embodiment is presented in Algorithm 1.

Algorithm 1 Redesign Algorithm

procedure REDESIGN(field, widget, disp_height)

| | |
|---|---|
| page ← 1 | [symbol] current page index |

| | |
|---|---|
| ht[1] ← disp_height | [symbol] initialize page height array |

with screen height for page 1

for k = 1 → n do

mincost ← 100000
for i = 1 → page + 1 do

for j = 1 → 9 do

mincost ← Cost(field[k], widget[j], ht[i])
if cost < mincost then

field[k].wid ← widget[j]
field[k].page ← i
field[k].ht ← MinHeight(field[k].wid)
mincost ← cost

end if

end for

end for
ht[field[k].page] ← ht[field[k].page] − field[k].ht
if field[k].page > page then

| | |
|---|---|
| page ← page + 1 | [symbol] create new page |

end if

end for

end procedure

Other considerations for determine costing 416 and assign widgets 418 that may be taken into account are that checkboxes may be used if and only if they were used in the original form, since these are the only widgets that allow multiple options. Further, a text field may be only used if it was a text field in the original form. If an item is converted to a dropdown or radio buttons to text, the innovation presumes that the user is aware of the options, which may not be true in all instances. However, it is always a possibility to convert a text field to non-text field, for query forms. Accordions may be used when there is a many to one foreign key relation between columns, where the headers are foreign keys and options are primary keys. Table 2 summarizes cost and restrictions for types of widgets in an embodiment.

TABLE 2

| Widget | Cost | Restrictions |
|---|---|---|
| Radio buttons | ${w}_{tap} + \frac{count}{display\_ht} \times {w}_{scroll}$ | Cannot be text field in original |
| | | form |
| Checkbox | ${w}_{tap} \times count + \frac{count}{display\_ht} \times {w}_{scroll}$ | Original form used checkbox |
| Rangesliders | w_{slide} × range of values | Numeric data type |
| Datepicker | range of months × wₜₐₚ + wₜₐₚ × range of years | Date data type |
| Segmented | wₜₐₚ | Count should |
| controller | | be low enough |
| | | to fit horizontally |
| | | on screen |
| Dropdown | count × w_{scroll} + 2 × wₜₐₚ | Cannot be text |
| | | field in original |
| | | form |
| Accordion | $\frac{{count}_{headings}}{display\_ht} \times {w}_{scroll} + \frac{{count}_{subheadings}}{display\_ht} \times {w}_{scroll} + 2 \times {w}_{tap}$ | Cannot be text field in original |
| | | form. Used for |
| | | fields with for- |
| | | eign key depen- |
| | | dencies |
| Toggle | wₜₐₚ | Binary data type |
| Text | length of longest data value × wtype | None |

In an embodiment, a widget choice may depend at least in part on a database that is linked to a corresponding form. Each form field may correspond to a database column. Schema, data types and data distributions may dictate a form design. For schema relations such as one to many, the disclosed innovation can ensure that a parent field appears before its children. Further, in this scenario the disclosed innovation may also use an accordion widget presented herein, where a parent field selection determines options to be displayed in subsequent fields.

Continuing with the embodiment, data types of a column allow for default keyboard that may be set, for example, may be set to numeric for integer and date fields. Moreover, some widgets may be reserved for certain data types such as for example range sliders for numeric values. Data distribution may determine default selections and ordering of options for dropdown and radio button fields. Options for a field may be ordered in a descending order of their frequencies in a database and default values may be set to one with a highest frequency.

It is to be appreciated that for embodiments with query forms there may be some considerations that are taken into account. Not all fields of such a form may be mandatory, hence applying a cost calculation to all form fields may not accurately capture a form completion time. One embodiment may extract only the mandatory fields from the HTML form and use only those in cost calculations. If the embodiment has access to query logs, than those logs may be used to assign weights to each field based on a frequency with which users use them to issue queries. Further, this information may be used in ordering the fields on a form as well, with more frequently used items placed in earlier pages.

In general, semantic grouping of an original form layout may be used for semantic groupings of fields. Fields that appear in the same field-set group may be kept on a same page. Another embodiment may assign a semantic cost between two fields based on their distance in an original form. For example, fields such as first and last name that are adjacent to each other in the original form would have a low semantic cost with respect to each other, while last name and occupation would have a higher one, thus encouraging semantic grouping of fields. In the absence of the original form layout, schema as well as label similarity may be analyzed for assigning semantic costs. It is to be appreciated that semantic grouping may be applied to a variety of forms.

Returning to a discussion of query forms, it is to be appreciated that query forms may rely completely on data and hence may allow for further optimizations. In another embodiment, if a field only has one value in the database, the innovation can remove it from the form, since the field can only have one value and allowing the user to select any other would return empty results. Moreover, if filling in information on the first page fully specifies the result set i.e., the rest of the fields can only have one value due to the information filled in the prior fields, the second page need not be shown at all. In this embodiment the form design would be changing as the user fills it. In another example, auto-completion may be implemented for text fields. An embodiment may factor for such in a widget cost calculation. Instead of using a length of a longest string, the length of a longest common prefix may be used to calculate typing cost.

For example, a passport form (similar to one that will be discussed later) may provide that United States appear first for a country of birth field based on frequency of data in an associated database to the passport form. Sequencing of options may reduce time spent on looking or scrolling through options. Furthermore, column data, widget and display dimensions together may determine a number of user interactions. For text widgets, a length of a data value may determines typing time, while for radio buttons a number of distinct values in a corresponding list from the database may determine scrolling time. As discussed earlier, the disclosed innovation uses these observations to develop a cost model to determine the most appropriate widget for a form field. State of art models, for example a models such as GOMS, may provide execution time estimates based on a system design that does not account for the data, unlike the disclosed innovation's cost function. Redesigning forms thus may be driven by underlying data, database and logic modules as opposed to a set technical presentation environment.

An aspect of the disclosed innovation provides that in an embodiment, widget selection may be driven by grouping fields. In certain environments with small size of screens, web pages either require the user to zoom or scroll along both dimensions. Empirical evidences suggest that scrolling reduces comprehension and slows processing. Thus, in an embodiment that reduces scrolling, a form may be split into multiple pages such that an entire page is visible on the screen at a readable font. As discussed previously, determining such a minimum number of multiple pages to be split while minimizing time is a type of NP hard problem since one ordering of fields might take less space than another. Optimizing may involve considering all orderings of fields, which is exponential in number of fields involved.

Another aspect of the disclosed innovation deals with time constraints: Time constraints for redesigning forms exist, since a user may request a webpage to be redesigned when they access it on their device, and time may impact whether a user will utilize any resulting display. A form may need to be redesigned on the fly, hence a transforming algorithm may maintain an interactive performance. A brute force approach to such interactivity is not practical since grouping n fields in different pages is equivalent to partitioning the set of n fields and the number of ways to do this is given by Bell number.

$$\begin{matrix}{B}_{n} = {\sum }_{k = 1}^{n} \{ \begin{matrix}n \\ k\end{matrix} \} \\ Where & ( 6 ) \\ \{ \begin{matrix}n \\ k\end{matrix} \} = \frac{1}{k !} {\sum }_{j = 0}^{k} {( - 1 )}^{k - j} ( \begin{matrix}k \\ j\end{matrix} ) {j}^{n} & ( 7 )\end{matrix}$$

is the Stirling number of the second kind which represents the number of ways to partition a set of n into k non-empty parts. The Bell numbers have a growth rate of θ(nⁿ). Hence, an algorithm of this type may not feasible within the time constraints for forms with a large number of fields. For a form with 16 fields there are B₁₆=10,480,142,147 subsets for which manual calculations would take hours and thus be defeating for the purpose of the technical environment.

It is to be appreciated that in the example embodiment discussed herein, mere manual application of any such algorithm would defeat the purpose of the technical environment, and thus such an approach would not be considered when redesigning (process would be considering each widget for each field i.e., 16 fields multiplied by 9 widgets, giving 144 possibilities just for determining an ideal widget for each field). Expand the consideration with a notion of taking a form and breaking it up into multiple pages, as well as considering on which page a field may be positioned in and an amount of space available, then an ideal widget processing is untenable. For example, if a brute force process were to split a form up into just 5 pages, there may be 10⁹ possible ways to split the form multiplied by 9 (as an example of select widgets) for which manual calculations would take hours and thus be defeating for the purpose of the technical environment.

At step 420 widgets and layout are generated. An algorithm may be termed a “greedy algorithm” as the application of the redesign step 404 traverses through a field list in an order in which the list is encountered and keeps track of the number of pages being used as well as display height available for each page and the number of elements on that page. For each field redesign step 404 may iterate through each page and locate a minimum cost widget given the remaining display height for each page and may select a page that has a minimum cost widget among all pages. The redesign step 404 may also calculate a minimum cost widget given a full display height of a new page and may compare the cost of widget+cost of creating a page which may be equal to a tap, with the cost of adding widget to a page that had a minimum cost and may select the lower of the two. Redesign step 404 may calculate a maximum height provided for displaying a field using a particular widget, which for radio buttons, checkboxes, and accordions may be count*30px, for date such may be 200px and for remaining options such may be 30px since others may be displayed on one line. It is to be appreciated that in some cases, scrolling may not be avoided, because a radio button may be used for a field, all of whose options may not fit on a page and hence requires scrolling, since it may be unintuitive to split the options for the same field into multiple pages. On adding a widget to an existing page, generating widgets/layout 414 step may update a remaining height by subtracting the new field height as well as may increase the number of elements for that page. On creating a new page, generating widgets/layout 414 step may add a remaining height and number of elements information to a page list. In an embodiment, a field may be annotated with the widget choice and page number.

It is to be appreciated that common optimization solutions such as integer linear programming and dynamic programming have a large search space. In contrast, using the equations (2), (3), (4) and (5) discussed previously, an embodiment of the disclosed innovation can model the solution as a 0-1 integer program. The embodiment can locate a subset X⊂Y such that each element in U appears exactly in one member of X i.e., each field appears in exactly one page and Σs∈x^{c}^{ₛ} is minimized. For each S∈Y, let xₛ equal to 1 if S is included in X, and 0 otherwise. Formally, the calculation is to minimize:

$${\sum }_{S ∈ Y} {c}_{S} {x}_{S} \qquad ( 8 )$$

Subject to the following constraints:

$${\sum }_{S \text{:} f ∈ S} {x}_{S} = 1 ∀ f ∈ U , {x}_{S} ∈ \{ 0 , 1 \} \qquad ( 9 )$$

For n fields and k widgets the cardinality of V is n×k, making the cardinality of Y approximately 2^{nk}. The power set of Y is then considered to generate the different page groupings corresponding to the xs giving rise to θ(2^{2nk}) for which costs have to be calculated. This is infeasible to solve using linear programming. A dynamic programming solution would desire locating a minimum over all permutations of the n fields since the display height and hence widget choice is affected by the ordering of the fields, which has growth rate of n!.

Given such constraints, the embodiment takes a “greedy approach.” The cost function enables clear selection of widgets, and splitting of pages where necessary. It uses space efficiently, since it places a field on a first page where it fits.

Returning to FIG. 1, step 106 Render is further discussed: during this step, an annotated list containing field, widget, page number and ordering may be taken to generate the HTML for each page being rendered. Rendering may provide radio button and checkbox widgets as buttons, with each option on a separate row with width equal to the width of the screen and a height of 30px. For radio button clicking on a button highlights it that indicate selection and unselects anything that was previously selected. Rendering of the checkbox is similar, except such allows multiple selections. For rendering text inputs, an entire width is available for typing and labels may be displayed as placeholder text on the input field, which reduces display space. Handles of a rendered range slider may be 20px×20px and that makes it easier for a user to select or manipulate. Rendered toggle inputs may be displayed on the same line as the label and clicking on the label toggles the selection as well. Finally, for rendering a default keyboard, such may be switched to numeric if a data type is numeric or date and to email if a label contains email.

Options may be sorted by a frequency in which they may appear in a database for dropdowns, radio buttons and checkboxes, the highest frequency being made a default selection in an embodiment. In some embodiments in which a user may be required to scroll because not all options are displayed on a screen, a cost of selection may be adjusted to only 2 for those to whom the default selection applies, while in a worst case, a cost of scrolling through all the options may be as calculated by the previously disclosed algorithm.

It is to be appreciated that for a form with n fields or a database with n columns, the disclosed innovation's process may yield a maximum of n pages since a field cannot be split across two pages. So the innovation's redesign phase may take θ(n²) to iterate through each page for each field in the worst case, given a constant number of widgets. Both the preprocessing and rendering phase take θ(n) time, so the innovation's overall algorithm is θ(n²) which is a significant improvement over a brute force algorithm that would take exponential time.

It is to be appreciated that rendering may not be made concurrently with the determinations of transformed forms, and that the associated database may capture the rendering outputs, catalogue them, analyze them, and provide for a variety of presentation options.

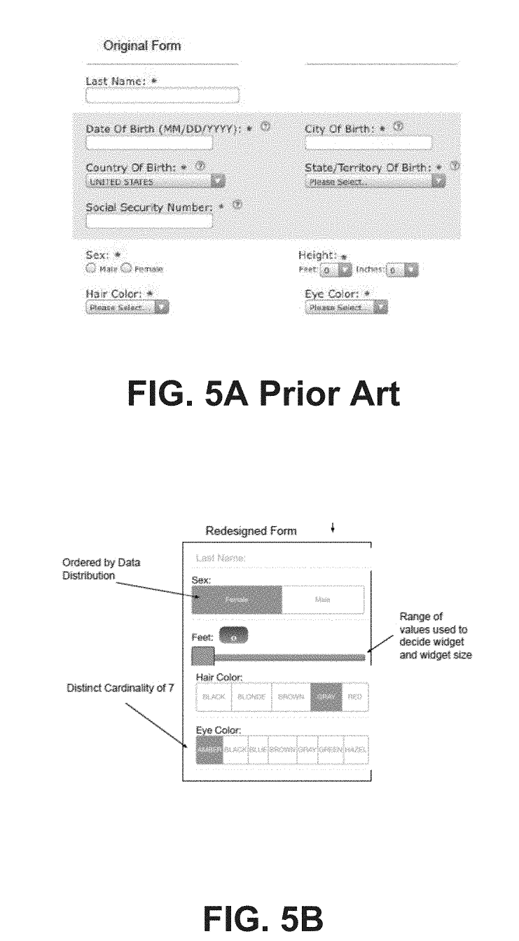

Turning now to FIGS. 5A and 5B, a detailed example of an embodiment of the disclosed innovation is presented as applied to a U.S. passport application form. This example demonstrates the difficulty of filling a desktop optimized form on a constrained device: FIG. 5A presents a form that may be present in an electronic communication environment, such as an internet browser, and represents an online “paper” form for a U.S. passport. FIG. 5B presents a transformed structure of a form that provides for improved processing in electronic communication environments that may be constrained, for example, on a smartphone, such as an iPhone 5s. For this example, presented are four input text fields: Name, which can have a length of up to 35 characters, date of birth can have 8, city of birth can have 25 characters, SSN (Social Security Number) requires 9 characters. It should be appreciated that a maximum number of characters and options to scroll through for each field are present from the original form.

The gender input field uses a radio button which just uses a tap on a desktop, but in a constrained technical communication environment, multiple taps may be used due to the environment constraints. Other fields use dropdown options, which may be presented in a slot machine style list, requiring a user to go through each option individually. An original form with this design may dictate that a use might have to scroll through 239 options for country of birth, in a worst case condition. Additionally, 77 options for state of birth, 10 options to select height in feet, 11 options for height in inches, 5 options for hair color and 7 options for eye color each necessitate user interaction.

It is to be appreciated that in technical communication environments different from those such as an original form may have been designed for, size constraints of a new and different communication environment may preclude a rendering of the original form in its entirety on a view screen. For a non-transformed rendering, a user would be required to scroll horizontally and vertically through the form, adding to the form completion time, as well as inducing more chance for misprocessing. In such a form as presented in FIG. 5A, fields such as date of birth and Social Security Number may require a user to navigate to the numeric keyboard, adding to the form completion time. In experimental trials, an extended version of this simple form took over 2 minutes to fill based on the average times of 15 users.

In the embodiment shown in FIG. 5B, a reduction in form completion time was achieved by reducing the number of fill-form interactions in the transformed structure of the embodied transformed form. Applying the methods disclosed herein, the disclosed innovation reconfigures with choices of widgets that allow a user to choose from a set of options which use one tap to select compared to several taps to type. Further, the disclosed innovation processes widget sizes to be large enough for a user to make a selection accurately without scrolling and zooming as such additional taps carry penalties of processing time and error opportunity. An embodiment of the disclosed innovation transformed the extended version of the original form to a rendering which took on average 1.5 minutes to complete, providing a approximate 25% reduction in user processing time.

As presented in FIG. 5B, it is to be appreciated that time reduction may stem from replacing dropdowns for country and modifying height in inches with radio buttons, feet with range slider, hair and eye color with segmented controllers, which reduces scrolling for the first fields and eliminates scrolling for the remaining ones. Dropdowns may provide a minimum of two taps, while the transformer restructured the form with widgets that may provide one tap. As noted earlier, the disclosed innovation provisions a choice of “United States” (for example) to appear first for a country of birth field based on frequency of data in an associated database to the passport form.

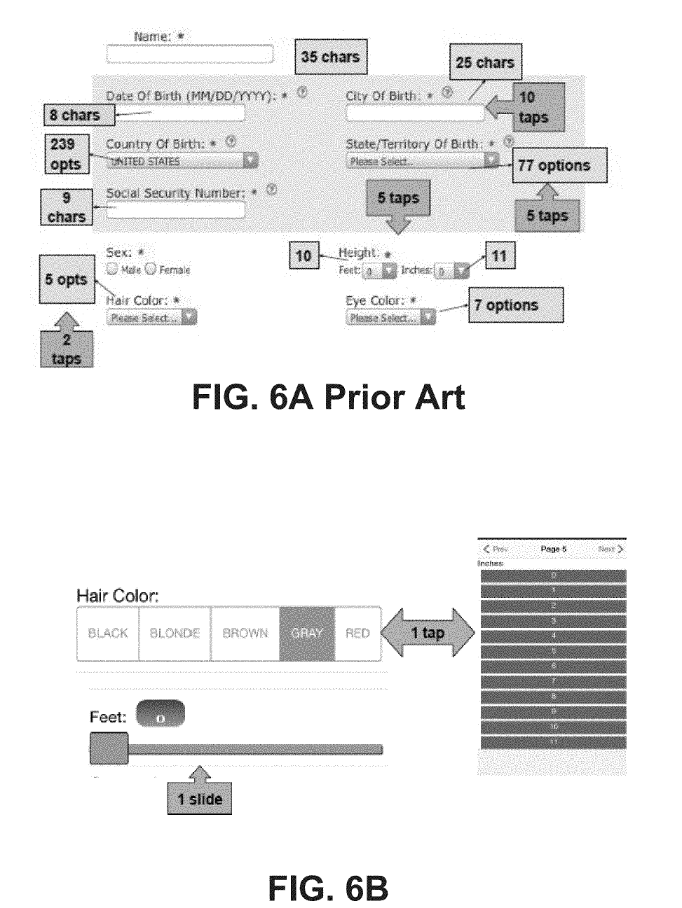

Turning now to FIGS. 6A and 6B, an additional embodiment contrasts the prior art form of FIG. 6A (the same prior art form of FIG. 5A as discussed previously), and highlights a transformed structure in accordance with aspects of the disclosed innovation. FIG. 6A illustrates a form showing a maximum number of characters and options to scroll through for each field as described in relation to FIG. 5A. Based on experimental studies, an average number of taps to make an entry are shown per original design form structure. FIG. 6B contrasts these results with an illustration of a transformed form with different widgets for fields that reduce the amount of user interaction, thus reducing form fill-time and process error opportunity.

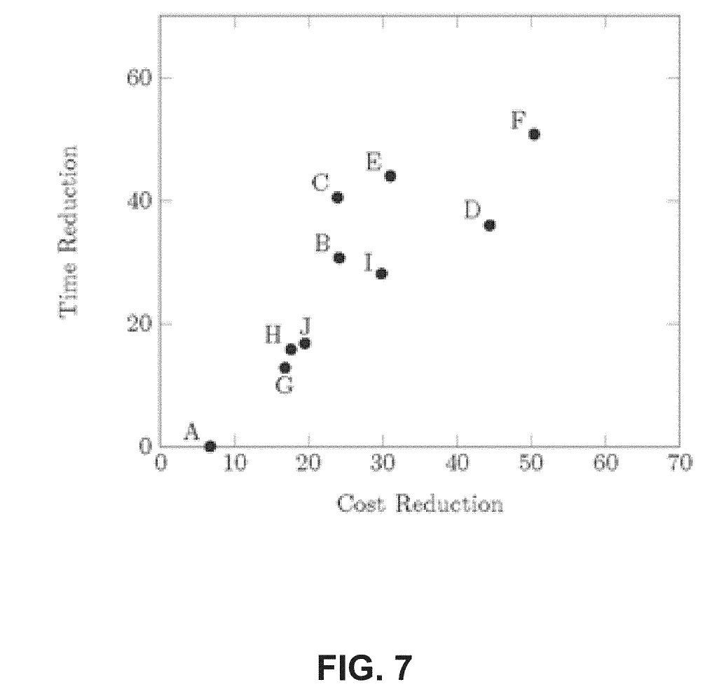

Turning now to FIGS. 7-10, various results are portrayed from experimental studies with an embodiment of the disclosed innovation across a number of original forms as processed in altered technical communication structures. Metrics that were evaluated include: accuracy, completion time, error rate and ease of use. Accuracy measures indicated accuracy of the embodiment's cost model processing as an approximation of a difficulty of filling the various forms. Completion time was calculated as the time it takes the user to fill in the form with predefined information. Error rate captured the number of times users had to hit backspace, or reselect a choice. In the experiments, after completing a form, a user was asked to rate the difficulty of filling the form on a scale of 1-10, 10 being most difficult. These metrics show the aspect of the disclosed innovation in capturing, by the cost function, a proxy of form completion time.

In the embodiment for which experimental results were obtained, a configuration was set as follows: an iPhone 5s running iOS 9.3.1, with 64 GB storage, 1 GB RAM and a 1136 px by 640 px screen with a resolution of 326 pixels per inch. An older version of the iPhone was chosen to emphasize an electronic communication constraint of a smaller display, which emphasizes that some technical environments will have form-fill difficulties. The forms were implemented in HTML5 and CSS.

In this embodiment, an algorithm evaluated a total of ten forms in a combination of data collection and query forms. For each form a database corresponding to the fields of the form was created and filled with synthetic data having uniform distribution. Forms, as shown in Table 3, were chosen to capture various widget combinations and lengths, as well as activities that a user may perform on their phones. Each original form was redesigned manually as well as per the embodiment of the disclosed innovation, yielding three versions of each form for a total of 30 forms. Information filled in by each user was standard and provided in the order to control for motor memory as well as to ensure entered texts were of the same length. This embodiment features an algorithm modified to order alphabetically instead of by frequency since the data to be filled in was predefined, and no query logs of forms were used that may provide a benefit of ordering by frequency from such query logs. It is to be appreciated that embodiments of the disclosed innovation may capture such in operation.

TABLE 3

| Form | Title & Field Description |
|---|---|
| A | Personality Test: 10 fields with segmented controller having |
| | the following: YES, yes, uncertain, no, NO. |
| B | Pizza Order: 21 checkboxes, 2 dropdowns with 8 and 5 options. |
| C | Hilton Reservation: 1 text field, a pop up datepicker, buttons |
| | for adding rooms (up to 26) and 2 dropdowns with 4 options. |
| D | United Airlines: 1 radio button, 2 text fields, a checkbox, 3 |
| | dropdowns with 3, 12, and 30 options. The number of travelers |
| | is a dropdown with 8 categories, each has a stepper that goes up |
| | to 8. |
| E | Library Advanced Search: 37 checkboxes, 5 dropdowns, 4 |
| | with 4 options and one with 22. |
| F | Music Search: The genres have 20 options with each having |
| | sub-options the largest number being 302 in the form of |
| | checkboxes, 2 dropdowns with 96 options, 2 radio buttons and a |
| | text field. |
| G | Roommate Matcher: 5 text fields, 8 dropdowns with 2, 2, 5, 4, |
| | 3, 3, 4, 4 options, 3 radio button fields and 7 checkboxes and |
| | requires scrolling. |
| H | Maintenance Request: 4 text fields, 2 radio buttons and 5 |
| | dropdowns with 8, 2, 323, 105 and 37 options, and a pop up |
| | datepicker. |
| I | U.S. Passport Application: 9 text fields, 1 radio button field, 6 |
| | dropdowns with 239, 77, 10, 11, 5 and 7 options. |
| J | Room Reservation: 4 text fields, 2 pop up datepickers, 4 radio |
| | button fields, 5 dropdowns with 35, 5, 96, 96 and 7 options. |

Another aspect of the configuration of the experiments with the embodiment was the control of users for the study. 15 users consisting of graduate and undergraduate students from the University Campus were recruited for a within subject user study. In order to be eligible for the study, a user was to be smartphone users. Characteristics of the users were as shown in Table 4. Each user filled in the same set of 30 forms, however the order in which they filled the original version, transformed form and manual redesign for each form was randomized to account for learning bias. The order in which the forms were to be filled was pre-decided before meeting a user, to avoid bias based on their answers to a prestudy.

TABLE 4

| User | Daily Hrs on Phone | Age | Gender |
|---|---|---|---|
| 1 | 4 | 23 | Female |
| 2 | 4 | 20 | Male |
| 3 | 4 | 20 | Male |
| 4 | 1 | 28 | Male |
| 5 | 4 | 23 | Female |
| 6 | 2 | 22 | Female |
| 7 | 3 | 22 | Female |
| 8 | 7 | 23 | Female |
| 9 | 3 | 23 | Female |
| 10 | 1 | 21 | Male |
| 11 | 2 | 21 | Female |
| 12 | 5 | 24 | Male |
| 13 | 2 | 21 | Female |
| 14 | 3 | 23 | Male |
| 15 | 1 | 21 | Male |

Each user was evaluated individually for a study session which consisted of the following:
users were asked about their phone usage,
users were given printed information and asked to enter the information into forms on a phone provided to each user,
users were asked to say out loud any time they used backspace or make a reselection when filling in data,
a study conductor watched as users filled in forms and kept track of errors,
users were timed with a stopwatch from the moment they started typing till they hit submit,
after filling a form, a user was asked to rate the difficulty of the form,
a one minute break to the user was provided before the procedure for a next form was repeated.

An aspect of the disclosed innovation may include parameter tuning. As described supra, a cost function may be a weighted sum of all interactions. In an embodiment, the interactions may be weighted based on their contribution to a completion time. For example, in a technical communication environment involving an iPhone 4s, which has a smaller screen i.e., 960px by 640px, an embodiment may tune parameters in order to see how well a transformed form may translate to a different screen. In an experiment with this embodiment, weights were calculated for two users, timed as three forms which included 2 radio buttons, 8 text fields and 6 dropdowns that required scrolling were filled out. The time for text and dropdowns grew linearly with number of characters to type and number of options. It took on average one second to fill the radio button, 15.75 seconds for the text fields and 4.25 seconds to fill the dropdown options. With the example experiment assigning a weight of 16 for text and 4 for scrolling for a text field of 10 characters, an embodiment with a greedy algorithm selected a dropdown option over text field for up to 40 options. It is to be appreciated that other modification s to an algorithm may be made. For example, a set number of options may be designated as being too many options to scroll through. For the example embodiment for this parameter tuning aspect, a weight of 1 for tapping, 7 for typing and 3 for scrolling were assigned. For a slider, a weight of 0.5 was assigned, as even though tapping may be easier then sliding, in many cases a preference may be made for a slider as a slider may use less pixels vertically, i.e., 30 pixels as compared to 30n×pixels for n options.

An aspect of the disclosed innovation may involve using cost function as a proxy for form completion time. Experiments were conducted to confirm accuracy. In order to validate the cost function of an embodiment, a percentage of time reduced in filling out the redesigned form versus an original form were compared with a percentage of cost reduction between the redesigned and the original. Turning to FIG. 7, this comparison for each form of a set of forms discussed earlier is shown. A cost reduction was confirmed to be mostly proportional to a time reduction. As discussed previously, Form A is a personality test that has ten questions, each of which used segmented controller and had scrolling in the original form while a redesigned form split into 4 pages and increased the size of the widgets. Change in cost came from the scrolling, but with a negligible time difference. Form C (a room booking form for hilton hotel that had two fields for check in and check out date) presented an outlier. Clicking on either field presented a pop up datepicker on which both the check in and check out date could be selected. During the experiment, many users failed to understand this and would accidentally change the check in date while trying to select the check out date, taking additional time not captured by a particular embodiment of the disclosed innovation's cost model. In general, the innovation's model has been confirmed to be accurate in estimating the difficulty of the form as well as determining how much a transformed form can be improved.

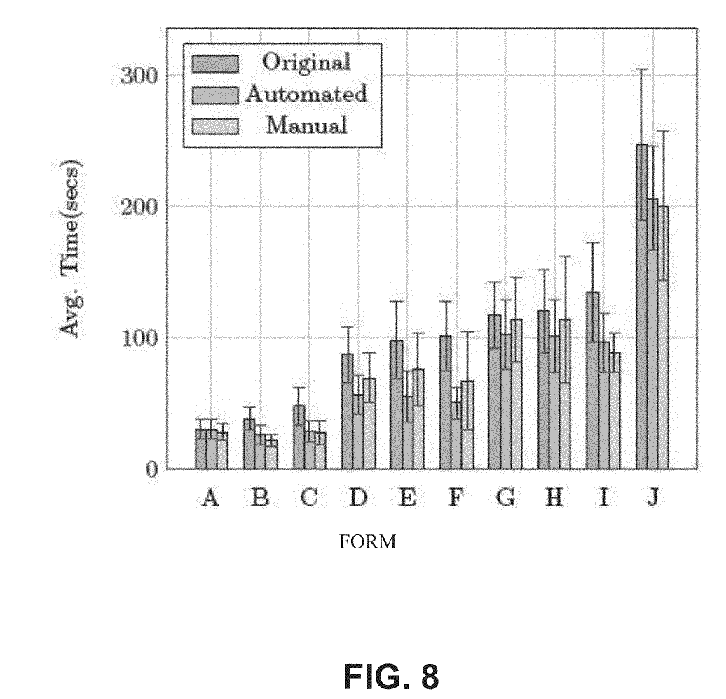

Form Completion Times: Turning to FIG. 8, results from testing an embodiment with an average completion time of 15 users for various forms (the original, transformed form and manual redesign version for the 10 forms as discussed previously) are presented. Table 5 provides a summary of decrease in average form completion time and increase in average rating of 15 users along with p-values of two tailed t-tests for 10 forms. Time decrease was statistically significant for most forms.

TABLE 5

| | Time | | Rating | |
|---|---|---|---|---|
| | Decrease | | Increase | |
| Form | (%) | p-value | (%) | p-value |
| A | 0.00 | 0.9 | −10.8 | 0.16 |
| B | 30.68 | 0.00 | 25.5 | 0.02 |
| C | 40.5 | 0.00 | 5.5 | 0.28 |
| D | 35.93 | 0.00 | 42.9 | 0.00 |
| E | 44 | 0.00 | 70 | 0.00 |
| F | 50.79 | 0.00 | 46.1 | 0.00 |
| G | 12.76 | 0.1 | 7.2 | 0.41 |
| H | 15.85 | 0.09 | 22.5 | 0.03 |
| I | 28.19 | 0.00 | 46 | 0.00 |
| J | 16.81 | 0.03 | 18.75 | 0.06 |

FIGS. 7 through 10 present absolute values. As noted earlier, for experiments with this embodiment, eliminating scrolling made no difference in form A, while forms G and H had many dropdown fields which were replaced with scrollable interfaces, but the options in the task were often in the top of the list, which is why the time reduction is not as large. The time reduction in form J is low due to the large number of text fields which were not transformed in the redesigned form. The embodiment of the innovation under discussion achieved the highest time reduction for forms that required zooming in and had small widget sizes. For example, form D and I required both horizontal and vertical scrolling, while forms E and F had very small widget sizes. The manual versions of forms A, B, C, I and J had lower completion times than the transformed versions but they were not statistically significant. An explanation for this is that fields were not grouped meaningfully in the embodiment's transformed forms. For example, Form A used a segmented controller for all its fields with the options Yes, yes, uncertain, no, No. The particular embodiment's transformed version displayed these options in alphabetical order i.e. No, Yes, no, yes, uncertain, which threw off users. Similarly, for form I the transformed version had the height in feet and height in inches on separate pages. Other embodiments address this issue. It is to be appreciated that experiments such as this provided embodiment variations to account for these aspects.

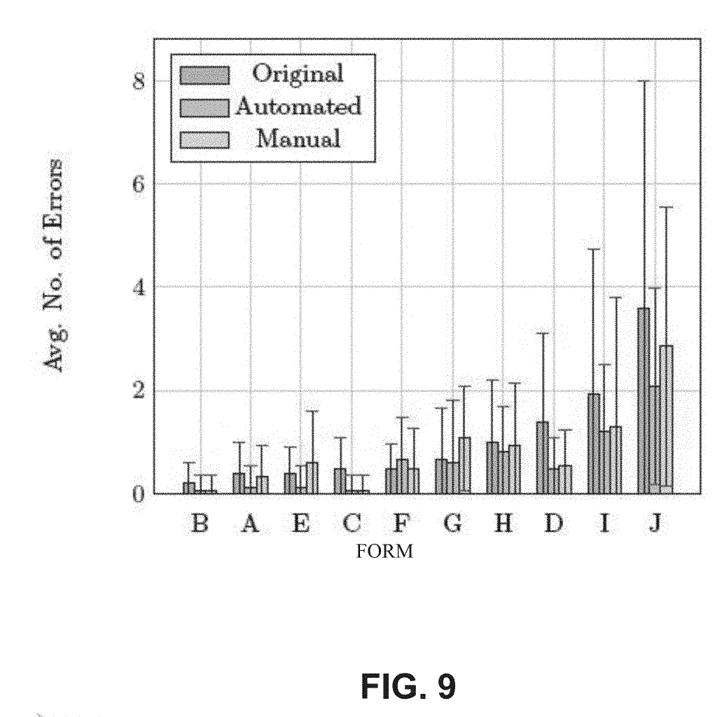

FIG. 9 shows an average error rates for each form of the embodiment in the experiment being discussed. The difference in error rates was not statistically significant for all but forms C and D. Most errors stemmed from text fields, as can be seen from the high error rates for forms I and J, and for which, the embodiment's calculations carried over the text fields. Transformed form F, the music browsing search form, had a higher error rate. Users were asked to select two subgenres from two genres. Both the original and the redesigned form displayed these as accordions, but while the original only required scrolling, the redesigned form split into multiple pages with genres being on the first page with the quantity of genres yielding scrolling. As a result, many users moved on to a next page after selecting a first genre and added a step to navigate back to select a next one, which resulted in the higher error rate. Except for forms F and J, the example embodiment's transformed form had fewer errors than the original.

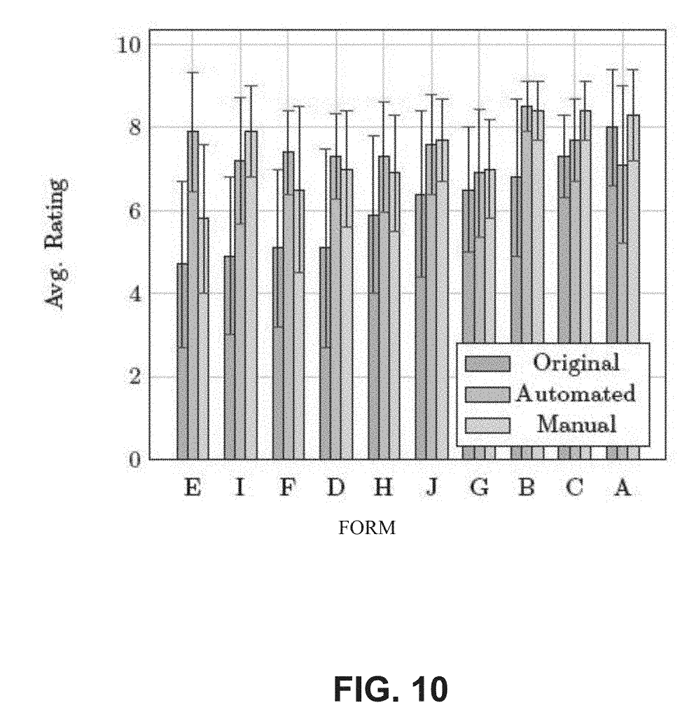

Turning to FIG. 10, results of the experiment with the embodiment being discussed for average rating of users regarding form-fill difficulty are shown, with 1 being very difficult, and 10 being very easy. User ratings aim to show user preference. It is to be appreciated that an aspect of manual forms that may yield ratings of being easier to fill out may be fields being grouped semantically during page splits. In one embodiment, transformed form A had a lower rating due to an alphabetical ordering of the options (as described earlier). For the most part, the embodiment's restructured forms were rated significantly higher, showing that users preferred the results of the example embodiment.

Other observations of the embodiment in the experiment under discussion include the observation that the use of slot machine style dropdowns in an iOS is time consuming. Form F had an option of limiting results by specifying the start and end year. Both of these fields were represented as dropdowns ranging from 1920 to 2016. Even though this representation was unexpected, users were able to fill in the form much quicker.

Another observation is that Text fields provide on average 20 seconds and that the innovation's high weight for this was suitably captured this in the example embodiment's cost model.

Embodiments may address the result that some forms in the example experiment displayed ambiguity in language and structure of a form. For example, underestimation of the original cost of form C was a function of evaluating the difficulty from a user interaction perspective. In another example, a low performance of transformed form A provides for embodiments with semantic ordering of fields to address these points. Definition of a cost function based on data of form fields may be used to evaluate the optimality of a form given a queried database. This may provide for e selection of a particular widget for a field and also may provide a guide for grouping fields together.

It is to be appreciated that in certain technical communication environments, for example, on a smartwatch, various cast factors such as the cost of typing and scrolling may be exacerbated. Embodiments may tune an algorithm to capture scrolling on a watch that may be presumed to take twice as long as on a phone. This may be reflected in an expected cost improvement, for example in a Passport Application (Form I), of 50% for a watch, compared to an expected 30% for a phone.

Experimental evaluation of one implementation of the innovation shows that there is up to 50% reduction in form completion time. There is also a 70% improvement in user rating from original to the redesigned. Thus, transforming forms with the innovation leads to easier machine interactions and hence quicker form completion.

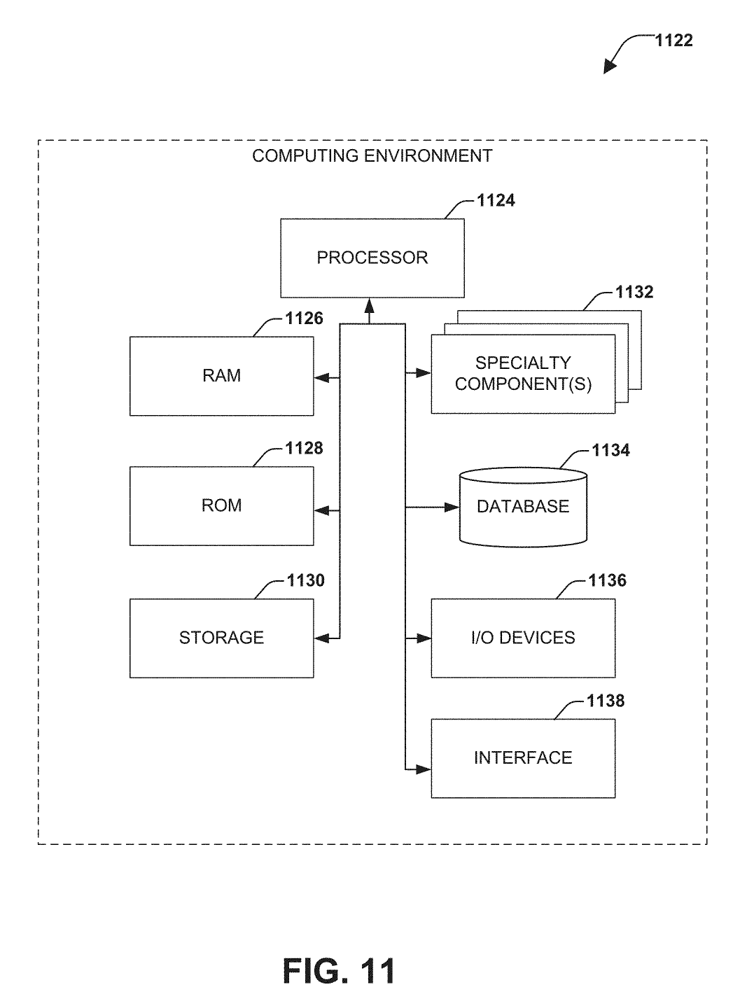

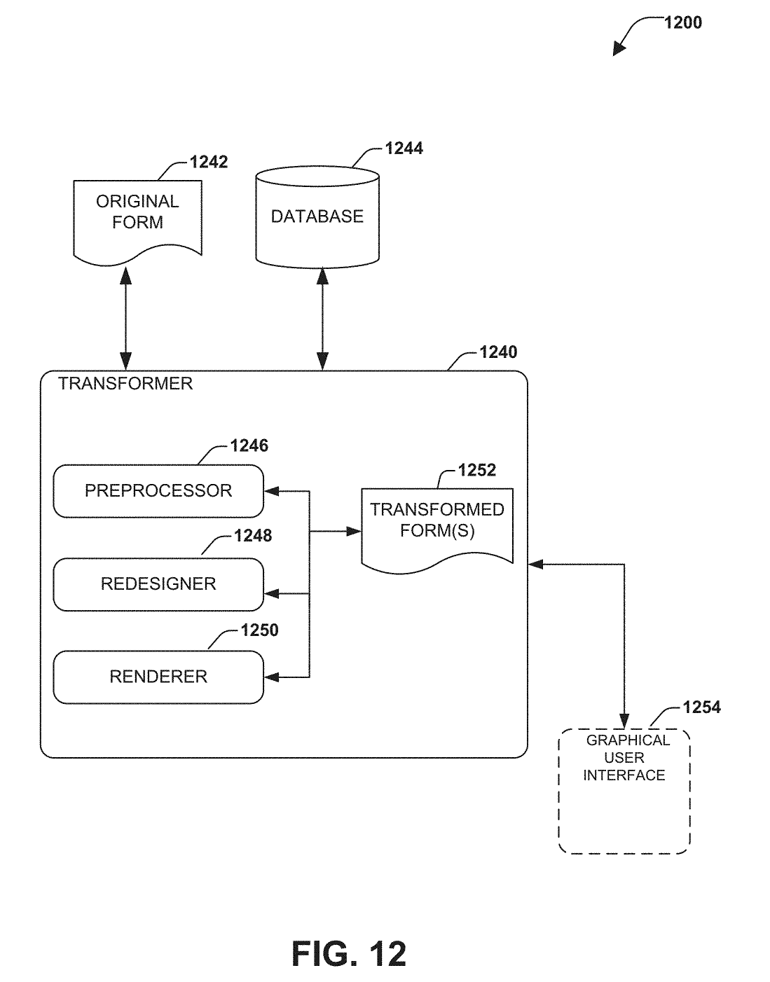

FIG. 11 illustrates an example computing environment 1122 that can be used for configuring hardware devices in accord with aspects of the disclosed innovation. In various aspects, the computing environment of FIG. 11 may comprise all or a portion of a transformer system 1200 as will be discussed in relation to FIG. 12. As used herein, “computer” may include a plurality of computers. The computers may include one or more hardware components such as, for example, a processor 1124, a random access memory (RAM) module 1126, a read-only memory (ROM) module 1128, a storage 1130, a database 1134, one or more input/output (I/O) devices 1136, and an interface 1138. Alternatively and/or additionally, controller 1120 may include one or more software components such as, for example, a computer-readable medium including computer executable instructions for performing a method associated with the exemplary embodiments. It is contemplated that one or more of the hardware components listed above may be implemented using software. For example, storage 1130 may include a software partition associated with one or more other hardware components. It is understood that the components listed above are exemplary only and not intended to be limiting.

Processor 1124 may include one or more processors, each configured to execute instructions and process data to perform one or more functions associated with a computer for indexing images. Processor 1124 may be communicatively coupled to RAM 1126, ROM 1128, storage 1130, database 1134, I/O devices 1136, and interface 1138. Processor 1124 may be configured to execute sequences of computer program instructions to perform various processes. The computer program instructions may be loaded into RAM 1126 for execution by processor 1124. As used herein, processor refers to a physical hardware device that executes encoded instructions for performing functions on inputs and creating outputs.

RAM 1126 and ROM 1128 may each include one or more devices for storing information associated with operation of processor 1124. For example, ROM 1128 may include a memory device configured to access and store information associated with controller 1120, including information for identifying, initializing, and monitoring the operation of one or more components and subsystems. RAM 1126 may include a memory device for storing data associated with one or more operations of processor 1124. For example, ROM 1128 may load instructions into RAM 1126 for execution by processor 1124.

Storage 1130 may include any type of mass storage device configured to store information that processor 1124 may need to perform processes consistent with the disclosed embodiments. For example, storage 1130 may include one or more magnetic and/or optical disk devices, such as hard drives, CD-ROMs, DVD-ROMs, or any other type of mass media device.

Specialty component(s) 1132 may include one or more software and/or hardware components that are configured to provide a specialty function. For example, one or more of the components discussed in relation to FIG. 12, such as transformer 1240, preprocessor 1246, redesigner 1248, and/or renderer 1250 may be configured to be a specialty component.

Database 1134 may include one or more software and/or hardware components that cooperate to store, organize, sort, filter, and/or arrange data used by controller 1120 and/or processor 1124. For example, database 1134 may store hardware and/or software configuration data associated with input-output hardware devices and controllers, as described herein. It is contemplated that database 1134 may store additional and/or different information than that listed above.

I/O devices 1136 may include one or more components configured to communicate information with a user associated with controller 1120. For example, I/O devices may include a console with an integrated keyboard and mouse to allow a user to maintain a database of images, update associations, and access digital content. I/O devices 1136 may also include a display including a graphical user interface (GUI) for outputting information on a monitor. I/O devices 1136 may also include peripheral devices such as, for example, a printer for printing information associated with controller 1120, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 1138 may include one or more components configured to transmit and receive data via a communication network, such as the Internet, a local area network, a workstation peer-to-peer network, a direct link network, a wireless network, or any other suitable communication platform. For example, interface 1138 may include one or more modulators, demodulators, multiplexers, de-multiplexers, network communication devices, wireless devices, antennas, modems, and any other type of device configured to enable data communication via a communication network.

Turning now to FIG. 12, presented is a system view 1200 of components of an embodiment of the disclosed innovation. It is to be appreciated that system view 1200 may be configured to perform any of the methods of the embodiments of the disclosed innovation, including those methods discussed in relation to FIGS. 1-10. It is to be further appreciated that like-named components of system view 1200 may be specialty components as discussed in relation to FIG. 11 computing environment 1122, or in some embodiments, may be hardware and/or software that is configured through non-specialty components as discussed in relation to FIG. 11 computing environment 1122. Further, in embodiments, the components of system 1200 are to be recognized as components configured to perform like-named method steps as discussed herein and reflected in discussions of FIGS. 1, 2 and 4, for example.

System view 1200 may include transformer 1240. In various embodiments, transformer 1240 may be configured to be hardware, software or a combination of hardware and software. Transformer 1240 may be configured to receive as input original form 1242. Original form 1242 may be an electronic form or a paper form. Transformer 1240 may also be in communicative connection with database 1244. In some embodiments (no shown), database 1244 may be a sub-component within transformer 1240. Database 1244 may be associated with original form 1242 as disclosed herein. It is to be appreciated that database 1244 may comprise multiple databases.

In embodiments, transformer 1240 may comprise preprocessor 1246. In various embodiments, preprocessor 1246 may be configured to be hardware, software or a combination of hardware and software. Preprocessor 1246 may be configured to perform functions as disclosed in relation to FIGS. 1-10.

In embodiments, transformer 1240 may comprise redesigner 1248. In various embodiments, redesigner 1248 may be configured to be hardware, software or a combination of hardware and software. Redesigner 1248 may be configured to perform functions as disclosed in relation to FIGS. 1-10.

In embodiments, transformer 1240 may comprise renderer 1250. In various embodiments, renderer 1250 may be configured to be hardware, software or a combination of hardware and software. Renderer 1250 may be configured to perform functions as disclosed in relation to FIGS. 1-10.

In embodiments, transformer 1240 may comprise output of one or more transformed form(s) 1252. It is to be appreciated that output transformed form(s) 1252 may be in communicative contact with a target graphical user interface 1254. In other embodiments, transformed form(S) 1252 may be created and at a later time provided to a target graphical user interface 1254. Transformed form(s) may be configured as disclosed in relation to FIGS. 1-10.

In embodiments, transformer 1240 may comprise graphical user interface 1254. In various embodiments, graphical user interface 1254 may be contained with transformer 1240. In other embodiments, graphical user interface 1254 may be outside of transformer 1240, but in communicative connection. It is to be appreciated that details of graphical user interface 1254 may be captured by transformer 1240 and may serve as inputs to the components of preprocessor 1246, redesigner 1248 and renderer 1250 in a process of creating transformed form(s) 1252. Details of graphical user interface 1254 may be captured and stored in database 1244. Graphical User Interface 1254 may be configured to perform functions as disclosed in relation to FIGS. 1-10.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for transforming technical communication presentations comprising the steps of
receiving as input a form that comprises fields;
receiving as input an identified user output device upon which a transformed form will be rendered;
preprocessing the input form, by a preprocessor, that creates a type-annotated intermediate representation by
extracting at least input fields from the input form,
capturing and annotating fields with data characteristics:
associating database values with a plurality of form field attributes based at least in part on data types of the form fields;
determining cost factors for data field widgets in the transformed form that are based at least in part on database values;
transforming the input form with a plurality of widgets, said transforming that applies a greedy algorithm that finds a minimum cost widget for the cost factors and generates field placement location based on the determined cost factors; and
rendering the transformed form on the user output device.

2. The method of claim 1, wherein preprocessing comprises processing a subset of forms that are unique or that may access the same database in subsequent use, either by a same or a different user, and said processing comprises leveraging previous captured inputs, and further wherein guides based on the leverage are provided for subsequent use.

3. The method of claim 1, wherein the input forms are comprised of a subset of query forms and that extracting occurs only for mandatory fields, and further wherein semantic grouping of fields is applied in the determining costing and further wherein auto-completion is engaged during use of the transformed form.

4. The method of claim 1, wherein in preprocessing, the data characteristics being annotated comprises details related to at least a subset of cardinality, range, lengths, original widget types, form schema, data types, and data distributions within the associated database.

5. The method of claim 4, wherein for a subset of forms with a data log in use, for the preprocessing, the data characteristics include a frequency of data per field.

6. The method of claim 4, wherein for a subset of forms, the data characteristics include a predetermined set of rules.

7. The method of claim 4, wherein the associating is further based at least in part on the attributes of the output device display, and that said associating enriches the intermediate representation with an ideal widget, page number and display height.

8. The method of claim 4, wherein the determining costing comprises evaluating the effort, time, and potential error rate of use of various widgets, both in original form and optimized transformed form and applies at least in part an addition of semantic grouping.

9. The method of claim 4, wherein the transforming further comprises the steps of assigning widgets that reflect cost and page placement calculations that generate a total cost of interaction of the transformed form to have a lower cost of interaction than that of the original form based at least in part on the constraints of the display characteristics of the target user device.

10. The method of claim 4, wherein the transforming is based at least in part on calculated cost factors that are based on tunable weights, wherein tunable weights may comprise predetermined factors or factors evolving through the associated database.

11. The method of claim 10 wherein the tunable weights may further comprise the data characteristics in at least a subset of distinct cardinality, string length, string category, string attributes, numerical range, numerical attributes, and data distribution per field in the associated database, and processing time aspects, and that said weights may set penalties.

12. The method of claim 4, wherein the transforming comprises assigning widgets based on an optimized tradeoff between form splitting into a plurality of pages and each page of the plurality of pages providing widgets that do not require scrolling to interact.

13. The method of claim 1, further wherein rendering the transformed form provides page(s) on the particular user output device display through generating HTML for each page of the redesigned form.

14. The method of claim 1, wherein the results of a transformation are tagged and stored for later display on a graphical user interface that belongs to a subset of user output devices.

15. A system comprising
a transformer component configured to
receive an input form,
wherein the form is independent of user output devices, and
wherein the form comprises fields, and
identify a particular user output device upon which a transformed form will be rendered;
a database that is associated with the input form and characteristics of form fields;
a graphical user interface associated with a subset of the user output devices;
wherein the transformer component comprises:
a preprocesser component that is configured to preprocess the input form that creates a type-annotated intermediate representation by
extracting at least input fields from the input form,
capturing and annotate fields with data characteristics:
associating database values with a plurality of form field attributes based at least in part on data types of the form fields;
a redesigner component that is configured to
determine cost factors for data field widgets in the transformed form that are based at least in part on database values;
transform the input form with a plurality of widgets, said transforming that applies a greedy algorithm that finds a minimum cost widget for the cost factors and generates field placement location based on the determined cost factors; and
a renderer component that is communicatively connected to the graphical user interface and is configured to render a transformed form.

16. The system of claim 15, wherein
for the preprocessor component, the intermediate representation is further annotated and comprises details related to at least a subset of cardinality, range, lengths, original widget types, form schema, data types, and data distributions within the associated database, and
further wherein for a subset of forms with a data log in use,
the intermediate representation is further annotated and comprises details related to a frequency of data per field, and
wherein for a second subset of forms,
the intermediate representation is further annotated and comprises details related to data characteristics that include a predetermined set of rules.

17. The system of claim 15, wherein the associating is further based at least in part on the attributes of the subset of user output devices, and that said associating enriches the intermediate representation with an ideal widget, page number and display height.

18. The system of claim 15, wherein the redesigner component is configured to
assign widgets that reflect cost and page placement calculations, said calculations generate a total cost of interaction of the transformed form and said assigned widgets have a lower cost of interaction than that of the original form based at least in part on the constraints of the display characteristics of the target user device, and
wherein the redesigner transforms a form based at least in part on calculated cost factors that are based on tunable weights,
wherein tunable weights may comprise predetermined factors or factors evolving through the associated database, the data characteristics in at least a subset of distinct cardinality, string length, string category, string attributes, numerical range, numerical attributes, and data distribution per field in the associated database, and processing time aspects, and that said weights may set penalties.

19. The system of claim 15, wherein the a renderer component renders the transformed form in at least one of provides page(s) on the graphical user interface through generating HTML for each page of the redesigned form, or wherein the results of a transformation are tagged and stored for later display on the graphical user interface.

20. A non-transitory computer readable medium storing computer-executable instructions that when executed by a computer cause the computer to perform a method, the method comprising:
taking as input a form configured as an HTML page,
wherein the form comprises fields,
taking as input an identified user output device upon which a transformed form will be rendered,
preprocessing the form through use of a hardware processor, a database module and a logic module
wherein database values associate the form with form field attributes based at least in part on data types expected for the form fields,
wherein the logic module identifies a plurality of widgets for rendering form fields on a plurality of user output devices;
redesigning the form through the logic module,
wherein the logic module calculates a minimum widget cost per form field,
wherein calculating is based at least in part on attributes of form fields and output device display, and
wherein the wherein each selected widget/field pair has the lowest calculated cost per user identified user device; and
rendering page(s) on the particular user output device display through generating HTML for each page of the redesigned form.
